(19) United States
(12) Patent Application Publication
(10) Pub. No.: US 2010/0161590 A1
(43) Pub. Date: Jun. 24, 2010

(54) QUERY PROCESSING IN A DYNAMIC CACHE

(75) Inventors: Hao Zheng, Saratoga, CA (US); George Mavromatis, Mountain View, CA (US); Dongni Chen, Sunnyvale, CA (US); Vanja Josifovski, Los Gatos, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnvale, CA (US)

(21) Appl. No.: 12/338,504

(22) Filed: Dec. 18, 2008

(51) Int. Cl. G06F 17/30; G06F 7/00

(52) U.S. Cl. 707/722; 707/E17.014

(57) ABSTRACT

The subject matter disclosed herein relates to dynamically update an ad cache.

### BACKGROUND

1. Field

The subject matter disclosed herein relates to data processing, and more particularly to methods and apparatuses that may be implemented to dynamically update an ad cache through one or more computing platforms and/or other like devices.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. With so much information being available, advertising on the Internet often allows advertisers to target audiences viewing their advertisements. Use of the Internet for online advertising facilitates a two way flow of information between end users and advertisers. For example, an end user may request an ad and in doing so may provide information in the form of data that describes the end user in some manner. Conversely, traditional print and “hard copy” advertising may constitute a one-way flow of information from advertisers to end users.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is diagram illustrating a procedure for publishing of online advertising in accordance with one or more exemplary embodiments.

FIG. 2 is diagram illustrating a procedure for dynamically updating an ad cache in accordance with one or more exemplary embodiments.

FIG. 3 is diagram illustrating a procedure publishing of online advertising based at least in part on selectivity of one or more features associated with an ad query in accordance with one or more exemplary embodiments.

FIG. 4 is diagram illustrating a procedure for searching an ad cache with a cluster structure in accordance with one or more exemplary embodiments.

FIG. 5 is an illustration of a cluster structure for use with an ad cache in accordance with one or more exemplary embodiments.

FIG. 6 is schematic a block diagram illustrating an embodiment of a computing environment system in accordance with one or more exemplary embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

The World Wide Web includes vast amounts of information or content that may be displayed to an end user. For example, an end user may utilize an application program, such as a web browser, to display one or more electronic documents (such as web pages) provided by one or more content providers or web site operators. Under some circumstances, a web site operator or content provider may desire to display one or more online advertisements along with content requested by an end user. As used herein the phrase “ad,” “online advertisements,” “advertising,” and/or the like may include online pop-up ads, banner ads, and/or the like. Under some circumstances, it may be desirable to determine which online advertisement to display with a particular electronic document based at least in part on user centric information and/or electronic document centric information. For example, an advertisement for an auto dealership may, under some circumstances, be more effective if displayed along with an article relating to an auto show than that same advertisement would be if displayed along with an article relating to a movie review.

As used herein, the term “electronic document” may include any information in a digital format, of which at least a portion may be perceived in some manner (e.g., visually, audibly) by a user if reproduced by a digital device such as, for example, a computing platform. For one or more embodiments, an electronic document may comprise a web page coded in a markup language, such as, for example, HTML (hypertext markup language), and/or the like. However, the scope of claimed subject matter is not limited in this respect. Also, for one or more embodiments, such electronic documents may comprise one or more elements. Such elements in one or more embodiments may comprise text, for example, as may be displayed as part of a web page presentation. Also, for one or more embodiments, the elements may comprise a graphical object, such as, for example, a digital image. In a particular implementation, a web page may contain embedded references to images, audio, video, other web documents, etc. One common type of reference used to identify and locate resources on the web is a Uniform Resource Locator (URL).

Some exemplary methods and systems are described herein that may be used to dynamically update an ad cache. Such an ad cache may be utilized as a part of an ad search engine. Such an ad search engine may maintain such an ad cache as a memory component of the ad search engine. Such an ad cache may be utilized for returning an ad result in response to an ad query. Such an ad result may include one or more online advertisements. Such online advertisements may be described below as an ad unit. Such an ad unit may include a creative component. For example, such an ad unit may include text, graphic or video data (herein referred to as “creative component”). Additionally, metadata associated with such creative components may include one or more keyword terms associated with the ad unit. Such ad units may be delivered to an end user based at least in part on one or more forms of online marketing processes, such as on contextual advertising, search advertising, search engine marketing, sponsored listings, and/or the like, and/or combinations thereof, for example.

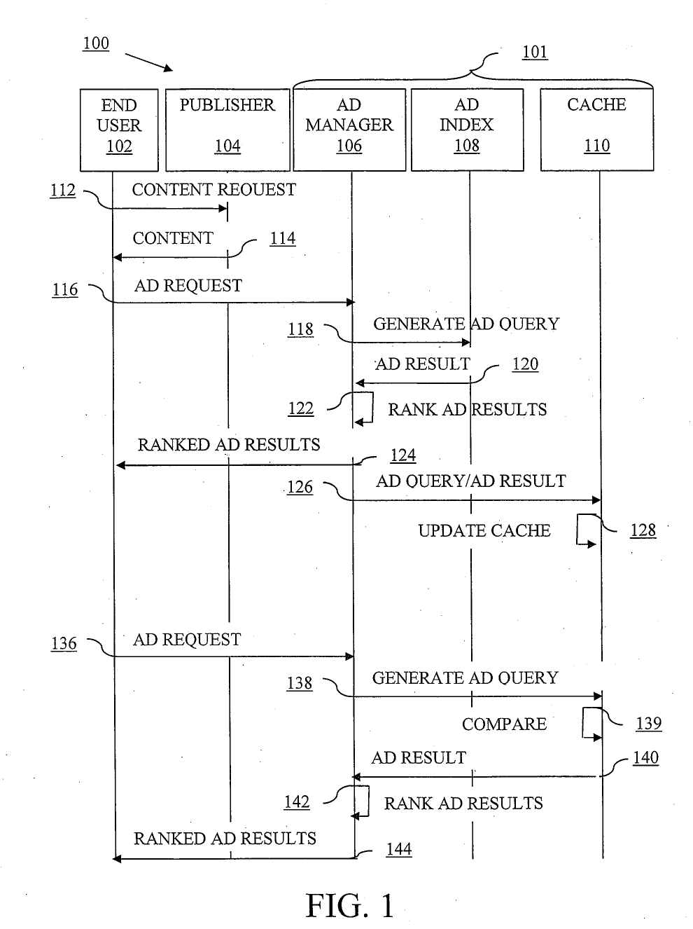

Referring to FIG. 1, a flow diagram illustrates a process for publishing of online advertising in accordance with one or more embodiments. Although process 100, as shown in FIG. 1, comprises one particular order of actions, the order in which the actions are presented does not necessarily limit claimed subject matter to any particular order. Likewise, intervening actions not shown in FIG. 1 and/or additional actions not shown in FIG. 1 may be employed and/or actions shown in FIG. 1 may be eliminated, without departing from the scope of claimed subject matter.

Process 100 depicted in FIG. 1 may in alternative embodiments be implemented in software, hardware, and/or firmware, and may comprise discrete operations. As illustrated, an ad search engine 101 may include an ad manager 106, an ad index 108, and an ad cache 110. Additionally or alternatively, ad search engine 101 may include additional components not illustrated here. Ad manager 106 may be coupled in communication with one or more publisher devices 104 associated with one or more publishers. Ad manager 106 may include an ad server operative to handle requests from publisher devices 104 and transmit data to publisher devices 104.

During typical online activity, an end user 102 may request a page and/or other like data file(s) of content from publisher device 104, as illustrated at action 112. Publisher device 104 may, in turn, return a content page to the end user, where the content page may contain a link and/or the like to a request for an advertisement from ad manager 106, as illustrated at action 114. In the illustrated embodiment, ad manager 106 may handle ad requests for advertisements from end users 102, as illustrated at action 116. Such an ad request for advertisement may include an HTTP request for advertising content initiated by a content page provided by publisher devices 104 to end users 102. For example, a request for advertisements may contain one or more current contextual features associated with a given end user including user centric data and/or publisher centric data. Such user centric data may include or otherwise be associated with an end user demographic (e.g. age, gender, income, and/or the like), end user location (e.g. continent, country, state/providence, city, zip, and/or the like), time (e.g. end user time, advertiser time, coordinated universal time (UTC), and/or the like), end user interests (e.g. sports, politics, and/or the like), and/or the like., and/or combinations thereof. Such publisher centric data may include or otherwise be associated with publication content (e.g. shopping, search, and/or the like), publication Uniform Resource Locator (URL), publication domain, publication site, and/or the like, and/or combinations thereof. For example, an ad request may specify features such as user centric data including end user gender, such as male or female, and/or the like. Similarly, an ad request may specify features such as user centric data including end user age, such as age in years, by birthday, and/or the like, for example. Likewise, an ad request may specify features such as user centric data including end user location, such as a geographic location, address, latitude and longitude, Global Positioning System location, and/or the like, for example. Further, an ad request may specify features such as user centric data including end user time, such as a time of day, time zone, and/or the like, for example. Likewise, an ad request may specify features such as, publisher centric data including publication content, such as topic areas associated with such content, key words associated with such content and/or the like, for example. Further, an ad request may specify features such as publisher centric data including publication URL, publication domain, and/or publication site that may refer to all or a portion of a string of characters used to represent a resource available on the Internet, for example. For example, an ad request may specify that the requesting content page is directed towards “sports”, located on the domain “example.com”, that the end user is a male between the ages 18 and 25, and that the end user is located in California.

In the illustrated embodiment, ad manager 106 may be operative to generate an ad query based at least in part on such an ad request, as illustrated at action 118. Such an ad query may be sent to ad index 108. Ad index 108 may provide an index of ads. For example, index 108 may parse a given ad into indexable terms, such as keyword terms that may be associated with concepts and/or entities. Such concepts and/or entities may include, but are not limited to, words, phrases, categories, topics, geographical information, and/or the like. Index 108 may index such terms and may store information regarding which ads contain a given concept and/or entity based at least in part on such indexed terms.

Ad manager 106 may receive an ad result set from index 108 based at least in part on ad query 118, as illustrated at action 120. Ad manager 106 may be capable of ranking such an ad result set such that the most relevant ads in the ad result set are presented to a user, according to descending relevance, as illustrated at action 122. For example, a first ad in such a ranked ad result set may be the most relevant in response to an ad query. Likewise, a last ad in such a ranked ad result set may be the least relevant while still falling within the scope of the ad query. Such a ranked ad result set may comprise an ad result that is transmitted to end user 102, as illustrated at action 124. In one embodiment, such ranking may consider user centric data and/or publisher centric data.

In some situations, it may be cost effective to use prior ad query/ad result searches in processing a subsequent ad request. In order to facilitate such use of prior ad query/ad result searches, a cache 110 may be utilized. In one example, ad search engine 101 may maintain ad cache 110 as a memory component of ad search engine 101, although the scope of claimed subject matter is not limited in this respect. For example, cache 110 may receive prior ad queries and/or ad results at action 126. Upon receiving such ad queries and/or ad results, cache 110 may be updated to incorporate additional ad query/ad result searches, as illustrated at action 128. As will be discussed in greater detail below, such an update may be a dynamic update. As used herein the term “dynamic update” may refer to an update to cache 110 that does not require rendering cache 110 unavailable for returning ad results, such as by rendering cache 110 unavailable by rebuilding all or a portion of the entire cache during an update.

As illustrated at action 136, a subsequent ad request may be received at ad manager 106. Ad manager 106 may in turn send a subsequent ad query to cache 110, as illustrated at action 138. As illustrated at action 139, such a subsequent ad query may be compared with one or more prior ad queries stored in cache 110. Prior ad results associated with such prior ad queries may be identified based at least in part on such a comparison. Such identified prior ad results may be returned to ad manager 106, as illustrated at action 140. Such prior ad results may be ranked by ad manager 106, as illustrated at action 142, and returned to end user 102, as illustrated at action 144.

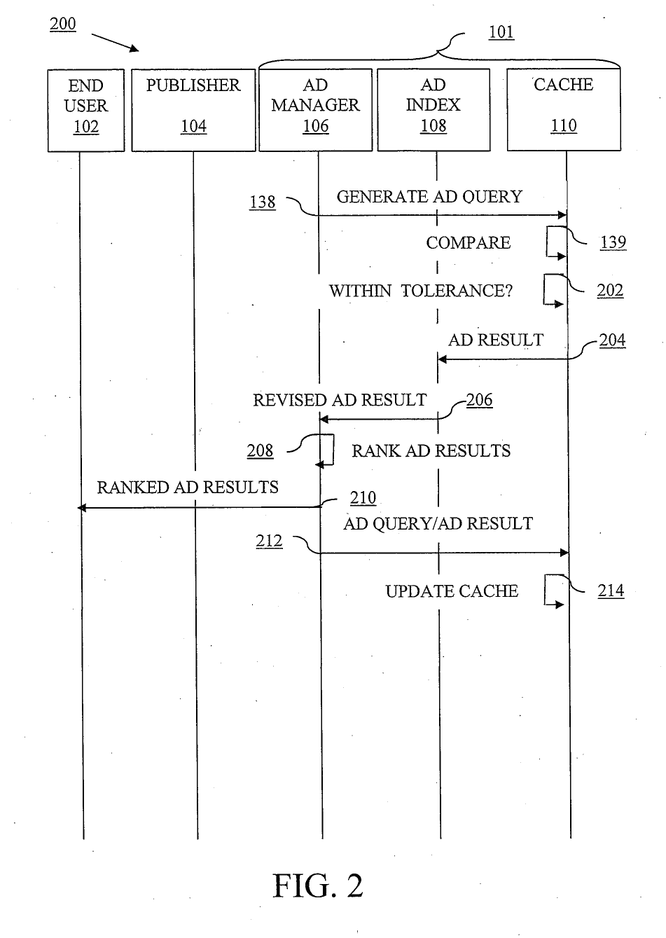

Referring to FIG. 2, a flow diagram illustrates a procedure 200 for dynamically updating an ad cache in accordance with one or more exemplary embodiments. As discussed above with regard to action 139, a subsequent ad query may be compared with one or more prior ad queries. Prior ad results associated with such prior ad queries may be identified based at least in part on such a comparison. In some situation such identified prior ad results may or may not be sufficiently similar according to a defined tolerance. At action 202 such identified prior ad results may be analyzed to determine whether such identified prior ad results fall outside of such a tolerance. In cases where such identified prior ad results do not fall outside of such a tolerance, such prior ad results may be returned to end user 102 via ad manager 106 (see FIG. 1). However, in cases where such identified prior ad results fall outside of such a tolerance, such prior ad results may be revised prior to returning such results to end user 102 via ad manager 106. For example, at action 204, such prior ad results may be returned to ad index 108 where ad index 108 may return revised ad results to ad manager 106, as illustrated at action 206. In one example, prior ad results may be discarded or may be used as baseline bounds to speed up a look-up of new ad results from ad index 108.ln an alternative implementation, results from ad index 108 and/or ad cache 110 may be delivered to ad manager 106, instead of ad cache 110 delivering to ad index 108 first. Such revised ad results may be ranked by ad manager 106, as illustrated at action 208, and returned to end user 102, as illustrated at action 210.

Additionally or alternatively, ad cache 110 may be dynamically updated based at least in part on such a subsequent ad query and/or such a revised second ad result. For example, such a subsequent ad query and/or such a revised second ad result may be received from ad manager 106 by cache 110, as illustrated at action 212. Ad cache 110 may be dynamically updated based at least in part on such a subsequent ad query and/or such a revised second ad result, as illustrated at action 214.

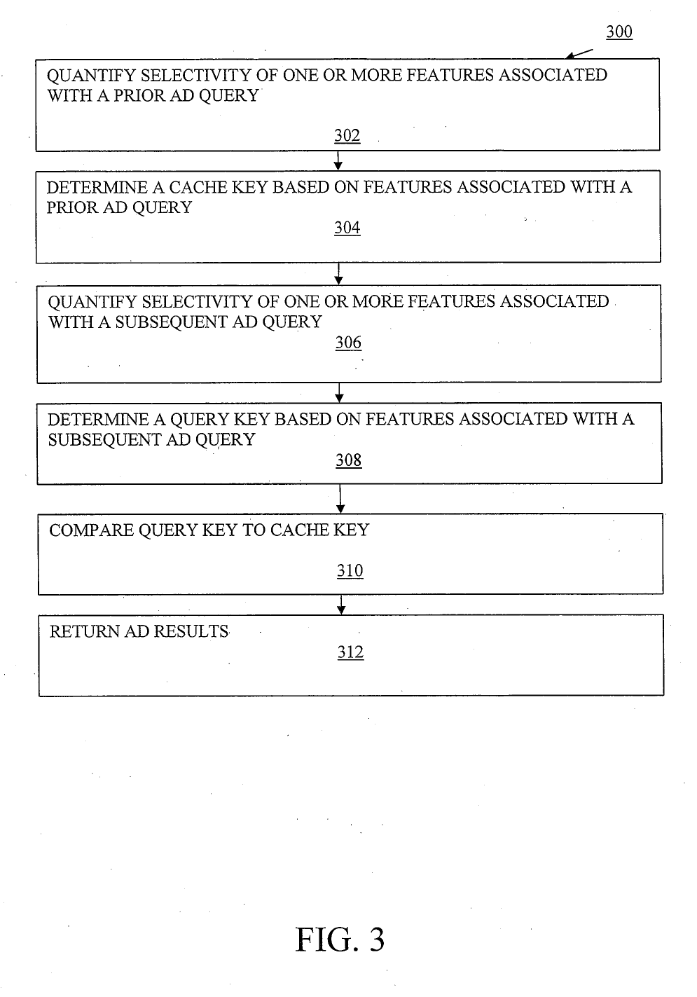

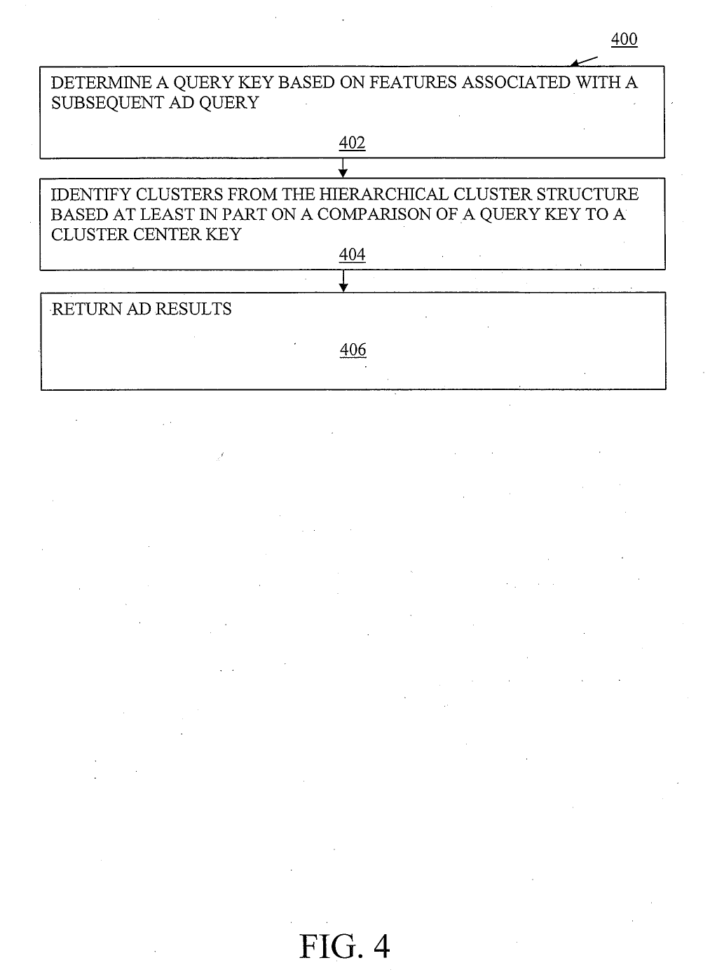

In operation, procedure 200 may be utilized to augment an ad search to ad index 108 by providing ad index 108 access to a preliminary search from ad cache 110. For example, as will be described in greater detail below with regard to FIG. 3 and/or FIG. 4, prior ad results identified via cache 110 may be within such a tolerance for certain aspects of subsequent ad query 138 (referred to herein as “features” of a query) while falling outside of such a tolerance for other features of subsequent ad query 138. As discussed above, the term “feature” may refer to aspects of an ad query associated with a given end user including user centric data and/or publisher centric data. Such features may have a varying degree of selectivity. As used herein the term “selectivity” may refer to a measure of how generic and/or how discriminating a given feature may be in regards to differentiating one ad query from another. Additionally, such features may have a varying degree of dynamisms. For example, a given ad query may include both relatively static features and/or relatively dynamic features. As used herein, a “static feature” may refer to an aspect of user centric data and/or publisher centric data that may change over a somewhat larger time scale. For example, a news article may be associated with one or more relatively static aspects, static features may include aspects related to particular content, such as words, categories, phrases, topics, subject matter, or the like. For example, for an article relating to a particular sports team, static features may include the type of sport, the name of the team, the subject of the article, or the like. As used herein, a “dynamic feature” may refer to an aspect of user centric data and/or publisher centric data that may be relatively dynamic and may change on a somewhat smaller time scale. For example, a dynamic feature may include information relating to one or more distinct users. In an embodiment, dynamic features may include information relating to a particular user, such as location data associated with the user, demographic information associated with a user, such as age, gender, etc., purchase history data, search history data, browsing history data, personal identification data, behavioral analysis data, or the like.

Accordingly, a given ad query containing both static features and dynamic features may be analyzed by cache 110. In some cases, cache 110 may be capable of matching both the static features and dynamic features to identify a prior ad result. In such a case, such prior ad results may be returned to end user 102 via ad manager 106 (see FIG. 1). In other cases, cache 110 may be capable of matching the static features but not the dynamic features when identifying a prior ad result. In such a case, such prior ad results may be revised via ad index 108 prior to returning such results to end user 102 via ad manager 106.

Referring to FIG. 3, a flow diagram illustrates a procedure 300 for publishing of online advertising based at least in part on selectivity of one or more features associated with an ad query in accordance with one or more exemplary embodiments. Procedure 300 may involve dynamically updating ad cache 110 (FIG. 1) by replacing a portion ad cache 110 based at least in part on a determination of a selectivity of one or more features associated with an ad query and/or an ad result.

At action 302, selectivity of one or more features associated with a prior ad query may be quantified. Such a quantification (also referred to herein as “weight”) may occur at cache 110. At action 304, a cache key may be determined based at least in part on one or more features. As used herein the term “key” may refer to a simplified representation of two or more values into a single value. As described below, a portion of such features may be included and/or excluded from a cache key based at least in part on such a quantification.

For example, such features may be chosen based at least in part on a quantified selectivity of such features, as quantified at action 302. In such a case, procedure 300 may be utilized to construct a dynamic cache 110 (FIG. 1) to capture recent query results, and to match subsequent ad queries against prior ad queries based at least in part on selectivity of one or more features associated with such subsequent and/or prior ad queries. For example, such features may be sorted based at least in part on such a quantification of such features. A portion of such features may be included and/or excluded based at least in part on a comparison to an established threshold value. In one example, such a threshold value may be based at least in part on a running of additional index queries to measure selectivity. Alternatively, such a threshold value may be based at least in part on an estimated score contribution of individual features, which may be utilized to prune features and apply thresholding on the query side weights. For example, such operation may be utilized by procedure 300 to drop certain features if they are not selective enough. Such a dropping of certain features may be utilized in searching ad cache 110 based on subsequent ad queries. Additionally or alternatively, such a dropping of certain features may be utilized in updating ad cache 110, such as described in FIG. 2, with prior ad queries.

At action 306, selectivity of one or more features associated with a subsequent ad query may be quantified. Such a quantification may occur at cache 110. At action 308, a query key may be determined based at least in part on one or more features. For example, such features may be chosen based at least in part on a quantified selectivity of such features, as quantified at action 306. As described above, a portion of such features may be included and/or excluded from a query key based at least in part on such a quantification.

At action 308, a comparison of such a query key may be made to such a cache key. For example, comparison 139 (FIG. 1 and/or FIG. 2) may comprise such a comparison of such a query key to such a cache key. Ad results may be returned to end user 102 (FIG. 1) via ad manager 106 (FIG. 1) based at least in part on such a comparison of a query key to a cache key, as illustrated at action 312.

In operation, procedure 300 may receive subsequent ad queries which include one or more features. As discussed above, such features can include user centric information and/or publisher centric information. A cache could have keys that use all of those features, since changes to any of such features can affect the ad results returned. However, because some of those features change fairly often (as different users often have different features), cache hit rates may be significantly lower than desired. Accordingly, procedure 300 may utilize a subset of such features to search cache 110 based on a given ad query. For example, for a feature set fs1 associated with a subsequent ad query, a similar feature set fs2 associated with a cached prior ad query may be found by dropping fs1's non-selective or less important features. In such a case, ad results associated with such a cached prior ad query may be similar enough to provide useful ad results to the subsequent ad query associated with feature set fs1.

Additionally or alternatively, some features from feature set fs1 may be replaceable with other similar features (fs3) during searching ad cache 110 based on subsequent ad queries. Further, such a replacing of certain features may be utilized in updating ad cache 110, such as described in FIG. 2, with prior ad queries. By dropping these less important or non-selective features, and/or replacing some features with similar features, subsequent ad queries may have a higher chance of being matched to prior queries, thus improving the cache hit rate.

Referring to FIG. 4, a flow diagram illustrates a procedure 400 for searching an ad cache with a cluster structure in accordance with one or more exemplary embodiments. Procedure 400 may utilize hierarchical clustering to dynamically detect similar data objects in cache 110 (FIG. 1) to reduce the storage requirement of cache 110. Such data objects in cache 110 (FIG. 1) may be represented within a hierarchical cluster structure. For example, ad queries and/or ad results may be represented within a hierarchical cluster structure based on one or more feature values and/or based on query keys.

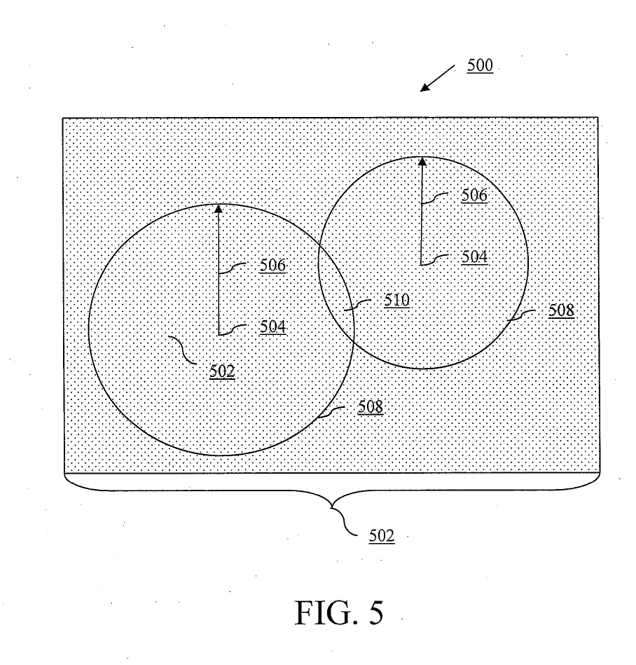

Referring to FIG. 5, a diagram illustrates a cluster structure 500 for use with an ad cache 110 (FIG. 1) in accordance with one or more exemplary embodiments. Cluster structure 500 may be represented in a metric space composed of a plurality of data objects. Such a metric space may be composed of a plurality of data objects 502. Such data objects 502 may represent previous ad results and/or ad queries that may be stored in cache 110 (FIG. 1 and/or FIG. 2). Such data objects 502 may be associated with a distance function defined among such data objects 502. Such a distance function may be utilized to determine the similarity between two given data objects 502. For example, such a distance function may be utilized to determine the similarity between a first ad query and a second ad query. In an ad manager context, a search of a given set of data objects may be performed based on a given ad query. In such a case, a cached ad result may be identified based on a comparison of such a given ad query with the given set of data objects within such a metric space. Additionally or alternatively, such a distance function may be based on ad query feature similarity, or ad result similarity, or both.

For example, such data objects 502 represented within metric space may be associated with an individual cluster center 504. In such a case, such data objects 502 may be represented based at least in part on a mapping of ad query feature and/or ad result features as vectors within metric space via such a distance function. For example, cache 110 (FIG. 1) may be built based at least in part on distributing a set of data objects 502 among a set of cluster centers 504 with associated radius 506. In such a case such data objects 502 may be associated with a given cluster center 504 within the extension of a given cluster 508 having a given radius 506 extending from such a cluster center 504. Such a cluster 508 may contain those data objects 502 that may be the closet data objects to a respective given cluster center 504. In some cases, those data objects 502 that are similar may be identified and stored in a compressed representation within the clusters 508. Additionally, such clusters 508 may overlap, such as at intersection 510. In such a case, a given data object 502 may assigned to one of such clusters 508.

For example, cluster structure 500 may be used to dynamically construct clusters 508 and/or to improve storage efficiency. One possible serving implementation may be to maintain more common ad query features as a key to a cluster 508. For example, cluster center keys may be determined for respective cluster centers 504. Such cluster center keys may be utilized to identify more common ad query features, while less dynamic features and/or less selective features may be represented by data object 502 within a given cluster. For example, such common ad query features may be identified based at least in part on associating weights with individual features to determine whether such features meet a defined threshold value for inclusion in such a cluster center key. Additionally or alternatively, such less dynamic features and/or less selective features may be represented by sub-clusters within a hierarchical cluster structure. In such a case, such clusters 508 sub-clusters may be formed so as to represent a varying degree of sensitivity to such less dynamic features and/or less selective features.

Additionally or alternatively, cluster structure 500 may include one or more inverted indexes. Such inverted indexes may be similar in structure to ad index 108 (FIG. 1). For example, such inverted indexes may be formed so as to be associated with individual clusters 508. In such a case, such inverted indexes might be specific to those data objects 502 associated with individual clusters 508. Accordingly, such inverted indexes might be significantly smaller than ad index 108 (FIG. 1).

In operation, cluster structure 500 may be utilized within cache 110 (FIG. 1) to reduce overlap of ad query feature within a metric space. Such a reduction in overlap may improve space efficiency and/or improve cache hit rates. Additionally, cluster structure 500 may be utilized to reduce incremental cost of storing dynamic features and/or to reduce the risk of polluting the cache. Further, in cases where hierarchical clustering is utilized in cluster structure 500, such hierarchical clustering may provide additional flexibility for constructing and/or serving cluster structure 500. For example, cluster structure 500 may provide a way to expand an ad query to other similar queries so as to include a richer set of candidates for ranking.

Referring back to FIG. 4, at action 402, a query key may be determined based at least in part on one or more features associated with a subsequent ad query. Such query keys may be utilized to identify more common ad query features, while less dynamic features and/or less selective features may be represented by data object 502 within a given cluster. For example, such common ad query features may be identified based at least in part on associating weights with individual features to determine whether such features meet a defined threshold value for inclusion in such a query key.

At action 404, one or more clusters may be identified from such a hierarchical cluster structure. For example, one or more clusters may be identified based at least in part on a comparison of such a query key to a cluster center key. Such a cluster center key may represent values of features associated with an individual cluster of such a hierarchical cluster structure. For example, such a cluster center key may represent values of features associated with a cluster center 504 (FIG. 5). As discussed above, with respect to FIG. 5, such cluster center keys may be utilized to identify more common ad query features. Additionally or alternatively, such less dynamic features and/or less selective features may be represented by sub-clusters within a hierarchical cluster structure. Such less dynamic features and/or less selective features associate with such a subsequent query may not be analyzed further, such as in situations where an identified cluster of data items is sufficiently close of a match to return an ad result. Additionally or alternatively, such less dynamic features and/or less selective features may be utilized to match such a subsequent query with sub-clusters within a hierarchical cluster structure. At action 406, all or a portion of prior ad results associated with an identified cluster may be included in a subsequent ad result that may be returned to end user 102 (FIG. 1) via ad manager 106 (FIG. 1).

In operation, procedure 400 may process ad queries with a large set of contextual features. Procedure 400 may be utilized improve query cache 110 (FIG. 1) performance by dynamically clustering ad queries to detect similar ad queries and reduce storage overhead. A hit rate for ad queries at cache 110 (FIG. 1), and/or an associated overall system performance, may depend at least in part on cache size and/or cache replacement policy. As discussed above, with respect to FIG. 2, an ad cache may be dynamically updated so that in situations where there is a cache miss, ad index 108 may be access to provide a revised ad result. Such a revised ad result may be evaluated to see if such a revised ad result should be entered into the ad cache 110. In cases where ad cache 110 is full, an evaluation may also be made regarding which data item in ad cache 110 is to be replaced. For example, selectivity, feature weights, and/or an overall evaluation score may be used to select a candidate to be replaced. Such cache updating (FIG. 2) and/or cache searching (FIG. 4) may use consistent cluster center keys and/or query keys. For example, in cases where thresholding based on the query feature weights is utilized in procedure 400 for cache searching, similar thresholding may be utilized in procedure 200 for cache updating. In cases where ad cache 110 includes a cluster structure, a revised ad result may either be dynamically added to an existing cluster and/or dynamically added to a new cluster. Alternatively, ad cache 110 may be reclustered in cases where the data set may be perturbed significantly enough to render a current cluster organization impractical. Due to the online runtime performance constraints, such reclustering may be performed offline to refresh ad cache 110.

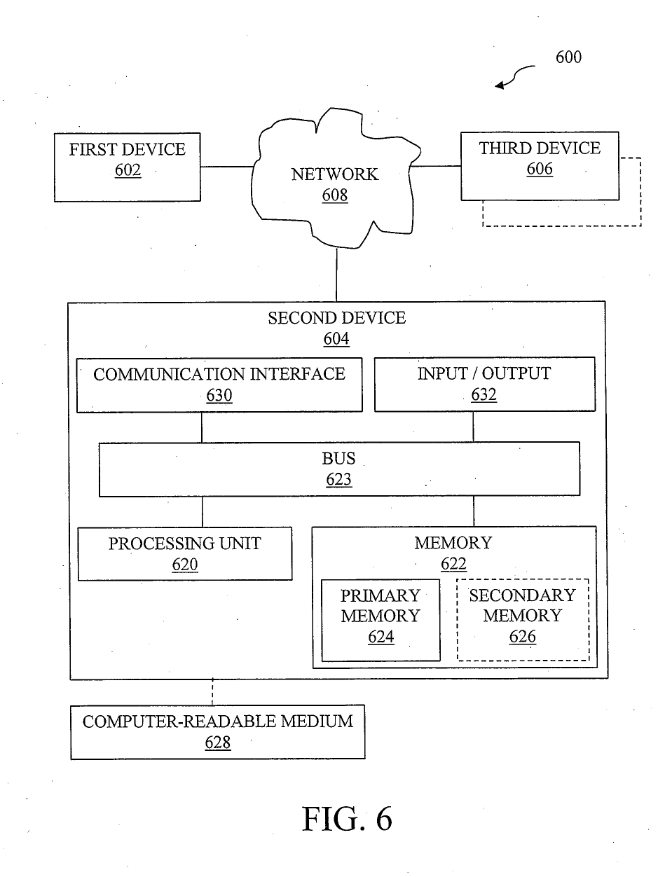

FIG. 6 is a block diagram illustrating an exemplary embodiment of a computing environment system 600 that may include one or more devices configurable to dynamically update an ad cache using one or more exemplary techniques illustrated above. For example, computing environment system 600 may be operatively enabled to perform all or a portion of process 100 of FIG. 1 and/or process 200 of FIG. 2.

Computing environment system 600 may include, for example, a first device 602, a second device 604 and a third device 606, which may be operatively coupled together through a network 608.

First device 602, second device 604 and third device 606, as shown in FIG. 6, are each representative of any device, appliance or machine that may be configurable to exchange data over network 608. By way of example, but not limitation, any of first device 602, second device 604, or third device 606 may include: one or more computing platforms or devices, such as, e.g., a desktop computer, a laptop computer, a workstation, a server device, storage units, or the like.

In the context of this particular patent application, the term “special purpose computing platform” means or refers to a general purpose computing platform once it is programmed to perform particular functions pursuant to instructions from program software. By way of example, but not limitation, any of first device 602, second device 604, or third device 606 may include: one or more special purpose computing platforms once programmed to perform particular functions pursuant to instructions from program software. Such program software does not refer to software that may be written to perform process 100 of FIG. 1, process 200 of FIG. 2, process 300 of FIG. 3 and/or process 400 of FIG. 4. Instead, such program software may refer to software that may be executing in addition to and/or in conjunction with all or a portion of process 100 of FIG. 1, process 200 of FIG. 2, process 300 of FIG. 3 and/or process 400 of FIG. 4.

Network 608, as shown in FIG. 6, is representative of one or more communication links, processes, and/or resources configurable to support the exchange of data between at least two of first device 602, second device 604 and third device 606. By way of example, but not limitation, network 608 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated by the dashed lined box partially obscured behind third device 606, there may be additional like devices operatively coupled to network 608, for example.

It is recognized that all or part of the various devices and networks shown in system 600, and the processes and methods as further described herein, may be implemented using or otherwise include hardware, firmware, software, or any combination thereof.

Thus, by way of example, but not limitation, second device 604 may include at least one processing unit 620 that is operatively coupled to a memory 622 through a bus 623.

Processing unit 620 is representative of one or more circuits configurable to perform at least a portion of a data computing procedure or process. By way of example, but not limitation, processing unit 620 may include one or more processors, controllers, microprocessors, microcontrollers, application specific integrated circuits, digital signal processors, programmable logic devices, field programmable gate arrays, and the like, or any combination thereof.

Memory 622 is representative of any data storage mechanism. Memory 622 may include, for example, a primary memory 624 and/or a secondary memory 626. Primary memory 624 may include, for example, a random access memory, read only memory, etc. While illustrated in this example as being separate from processing unit 620, it should be understood that all or part of primary memory 624 may be provided within or otherwise co-located/coupled with processing unit 620.

Secondary memory 626 may include, for example, the same or similar type of memory as primary memory and/or one or more data storage devices or systems, such as, for example, a disk drive, an optical disc drive, a tape drive, a solid state memory drive, etc. In certain implementations, secondary memory 626 may be operatively receptive of, or otherwise configurable to couple to, a computer-readable medium 628. Computer-readable medium 628 may include, for example, any medium that can carry and/or make accessible data, code and/or instructions for one or more of the devices in system 600.

Second device 604 may include, for example, a communication interface 630 that provides for or otherwise supports the operative coupling of second device 604 to at least network 608. By way of example, but not limitation, communication interface 630 may include a network interface device or card, a modem, a router, a switch, a transceiver, and the like.

Second device 604 may include, for example, an input/output 632. Input/output 632 is representative of one or more devices or features that may be configurable to accept or otherwise introduce human and/or machine inputs, and/or one or more devices or features that may be configurable to deliver or otherwise provide for human and/or machine outputs. By way of example, but not limitation, input/output device 632 may include an operatively enabled display, speaker, keyboard, mouse, trackball, touch screen, data port, etc.

Some portions of the detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

Reference throughout this. specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A method, comprising:
returning a first ad result to a user based at least in part on a first ad query via a computing platform;
dynamically updating an ad cache based at least in part on said first ad query and/or said first ad result; and
returning a second ad result to a user based at least in part on a comparison of a second ad query to said ad cache.

2. The method of claim 1, wherein said first and/or said second ad queries are based at least in part on user centric information and/or publisher centric information.

3. The method of claim 1, further comprising:
returning a revised second ad result if said second ad result falls outside of a given tolerance; and
wherein said revised second ad result is based at least in part on an ad index.

4. The method of claim 1, further comprising:
returning a revised second ad result if said second ad result falls outside of a given tolerance;
wherein said revised second ad result is based at least in part on an ad index; and
dynamically updating said ad cache based at least in part on said second ad query and/or said revised second ad result.

5. The method of claim 1, wherein said second ad result comprises one or more ranked ads.

6. The method of claim 1, wherein said dynamic updating of said ad cache comprises updating a cluster structure.

7. The method of claim 1, wherein said dynamic updating of said ad cache comprises updating a hierarchical cluster structure, the method further comprising:
determining a query key based at least in part on one or more features associated with said second ad query;
identifying one or more clusters from said hierarchical cluster structure based at least in part on a comparison of said query key to a cluster center key associated with an individual cluster of said hierarchical cluster structure; and
wherein said returning of said second ad result is based at least in part on one or more prior ad queries and/or ad results associated with said one or more identified clusters.

8. The method of claim 1, further comprising:
determining a query key based at least in part on one or more features associated with said second ad query;
identifying one or more clusters from a hierarchical cluster structure of said ad cache based at least in part on a comparison of said query key to a cluster center key associated with an individual cluster of said hierarchical cluster structure;
wherein said returning of said second ad result is based at least in part on one or more prior ad queries and/or ad results associated with said one or more identified clusters;
returning a revised second ad result if said second ad result falls outside of a given tolerance;
wherein said revised second ad result is based at least in part on an ad index; and
dynamically updating said ad cache based at least in part on said second ad query and/or said revised second ad result.

9. The method of claim 1, wherein said dynamically updating said ad cache comprises replacing a portion of said ad cache based at least in part on a determination of a selectivity of one or more features associated with said first ad query and/or said first ad result.

10. The method of claim 1, further comprising:
quantifying selectivity of one or more features associated with said first ad query;
determining a cache key based at least in part on one or more features chosen based at least in part on said quantified selectivity of said one or more features associated with said first ad query;
quantifying selectivity of one or more features associated with said second ad query;
determining a query key based at least in part on one or more features chosen based at least in part on said quantified selectivity of said one or more features associated with said second ad query; and
wherein said returning of said second ad result is based at least in part a comparison of said query key to said cache key.

11. An article comprising:
a storage medium comprising machine-readable instructions stored thereon, which, if executed by one or more processing units, operatively enable a computing platform to:
return a first ad result to a user based at least in part on a first ad query;
dynamically update an ad cache based at least in part on said first ad query and/or said first ad result; and
return a second ad result to a user based at least in part on a comparison of a second ad query to said ad cache.

12. The article of claim 11, wherein said machine-readable instructions, if executed by the one or more processing units, operatively enable the computing platform to:
return a revised second ad result if said second ad result falls outside of a given tolerance;
wherein said revised second ad result is based at least in part on an ad index; and
dynamically update said ad cache based at least in part on said second ad query and/or said revised second ad result.

13. The article of claim 11, wherein said dynamic update of said ad cache comprises updating a hierarchical cluster structure, wherein said machine-readable instructions, if executed by the one or more processing units, operatively enable the computing platform to:
determine a query key based at least in part on one or more features associated with said second ad query;
identify one or more clusters from said hierarchical cluster structure based at least in part on a comparison of said query key to a cluster center key associated with an individual cluster of said hierarchical cluster structure; and
wherein said return of said second ad result is based at least in part on one or more prior ad queries and/or ad results associated with said one or more identified clusters.

14. The article of claim 11, wherein said dynamically update to said ad cache comprises replacement of a portion of said ad cache based at least in part on a determination of a selectivity of one or more features associated with said first ad query and/or said first ad result.

15. The article of claim 11, wherein said machine-readable instructions, if executed by the one or more processing units, operatively enable the computing platform to:
quantify selectivity of one or more features associated with said first ad query;
determine a cache key based at least in part on one or more features chosen based at least in part on said quantified selectivity of said one or more features associated with said first ad query;
quantify selectivity of one or more features associated with said second ad query;
determine a query key based at least in part on one or more features chosen based at least in part on said quantified selectivity of said one or more features associated with said second ad query; and
wherein said return of said second ad result is based at least in part a comparison of said query key to said cache key.

16. An apparatus comprising:
a computing platform, said computing platform being operatively enabled to:
return a first ad result to a user based at least in part on a first ad query;
dynamically update an ad cache based at least in part on said first ad query and/or said first ad result; and
return a second ad result to a user based at least in part on a comparison of a second ad query to said ad cache.

17. The apparatus of claim 16, wherein said computing platform is further operatively enabled to:
return a revised second ad result if said second ad result falls outside of a given tolerance;
wherein said revised second ad result is based at least in part on an ad index; and
dynamically update said ad cache based at least in part on said second ad query and/or said revised second ad result.

18. The apparatus of claim 16, wherein said dynamic update of said ad cache comprises updating a hierarchical cluster structure, wherein said computing platform is further operatively enabled to:
determine a query key based at least in part on one or more features associated with said second ad query;
identify one or more clusters from said hierarchical cluster structure based at least in part on a comparison of said query key to a cluster center key associated with an individual cluster of said hierarchical cluster structure; and
wherein said return of said second ad result is based at least in part on one or more prior ad queries and/or ad results associated with said one or more identified clusters.

19. The apparatus of claim 16,wherein said dynamically update to said ad cache comprises replacement of a portion of said ad cache based at least in part on a determination of a selectivity of one or more features associated with said first ad query and/or said first ad result.

20. The apparatus of claim 16 wherein said computing platform is further operatively enabled to:
quantify selectivity of one or more features associated with said first ad query;
determine a cache key based at least in part on one or more features chosen based at least in part on said quantified selectivity of said one or more features associated with said first ad query;
quantify selectivity of one or more features associated with said second ad query;
determine a query key based at least in part on one or more features chosen based at least in part on said quantified selectivity of said one or more features associated with said second ad query; and
wherein said return of said second ad result is based at least in part a comparison of said query key to said cache key.
